(19) United States
(12) Patent Application Publication
(10) Pub. No.: US 2019/0105566 A1
(43) Pub. Date: Apr. 11, 2019

(54) GAME APPARATUS AND GAME SYSTEM

(71) Applicant: SQUARE ENIX CO., LTD., Tokyo (JP)

(72) Inventor: Sei SATO, Tokyo (JP)

(73) Assignee: SQUARE ENIX CO., LTD., Tokyo (JP)

(21) Appl. No.: 16/211,675

(22) Filed: Dec. 6, 2018

Related U.S. Application Data
(63) Continuation of application No. 14/031,495, filed on Sep. 19, 2013.

(30) Foreign Application Priority Data
Sep. 21, 2012 (JP) JP2012-207837

(51) Int. Cl. A63F 13/50; A63F 13/822

(52) U.S. Cl. CPC A63F 13/50; A63F 13/822

(57) ABSTRACT

A game apparatus and a method for operating the game apparatus are provided. The game apparatus includes an input device, a memory, and a processor. The input device receives an operating instruction from a player. The memory stores a list of game mediums of a player, and a first effect and a second effect corresponding to each of the game mediums. The processor designates a game medium to have, at a single point in time, only one of the first effect or the second effect for the game medium in accordance with the operating instruction. When the game medium is designated to have the first effect or the second effect, the processor retrieves from the memory, corresponding effect of the game medium to be applied upon execution and produces the corresponding effect.

### CROSS REFERENCE TO RELATED APPLICATION

This application is a continuation application of the pending U.S. patent application Ser. No. 14/031,495, filed on Sep. 19, 2013, which claims priority to Japanese Patent Application No. 2012-207837, filed on Sep. 21, 2012, the disclosures of which are expressly incorporated herein by reference in their entireties.

### TECHNICAL FIELD

The present invention relates to a game apparatus and a game system in which a strategic ability is required to select or set a skill or an item used when a player character fights against an enemy character.

### BACKGROUND ART

Role playing games (RPG) or action games that progress while the player character fights against the enemy character have been enjoyed in the past. In such games, a skill or the like available in the fight against the enemy character has previously been set from among a plurality of skills or items held by the player character so that the player character uses the set skill or the like in the fight against the enemy character.

The effect, for example, to damage the enemy character or to recover the physical strength of the ally character that is produced when the skill or the like is used is usually determined for each skill or item. Thus, a quite different effect is not produced depending on the time when the skill or the item is used. The variation of the effect is limited within a predetermined range although the size of the effect randomly varies. Thus, a highly strategic ability is not required to select a skill or the like to be used. Accordingly, the fight against the enemy character or the progress of the game itself sometimes becomes monotonous.

### SUMMARY OF INVENTION

### Technical Problem

To solve the above-mentioned problem, an objective of the present invention is to provide a game apparatus and a game system in which the interest of a game is improved and in which a strategic ability is required to select or set a skill or an item (hereinafter, also referred to as a “skill or the like”) used when the player character fights against the enemy character.

### Solution to Problem

The present invention relates to a game apparatus in which a game progresses by an action of a player character according to an operating instruction to an input device from a player comprising: an effect storage that stores a first effect and a second effect of a skill or an item; a first effect setuper that sets a skill or an item held by the player character at a state in which the first effect is capable of being produced; a second effect setuper that sets the skill or the item held by the player character at a state in which the second effect is capable of being produced; and an effect producer that produces the first effect and/or the second effect set capable of being produced by the first effect setuper and/or the second effect setuper according to the effects stored in the effect storage.

The player character can obtain a skill card or an item card (hereinafter, also referred to as a “skill card or the like”) by buying the card with a virtual currency, beating an enemy character, or clearing a predetermined quest. Setting the skill card or the like on a slot enables the player character to use the skill or the like corresponding to the skill card or the like.

According to the present invention, the skill card or the like can be set on one of a normal slot in which a first effect is produced and a wild slot in which a second effect is produced. The first effect (hereinafter, also referred to as a “normal effect”) and the second effect (hereinafter, also referred to as a “wild effect”) produce different effects from each other. Accordingly, even the same skill or the like produces a different effect depending on which slot the skill is set on.

As described above, which slot, the normal slot or the wild slot, the skill card or the like held by the player character is set on has a great effect on the progress of the game. Thus, the player needs to strategically determine to set which skill card or the like on the normal slot or to set which skill card or the like on the wild slot from among a plurality of skill cards or the like. As a result, the interest of the game is improved.

In the present invention, it is preferable that the game apparatus further comprising: an operating instruction receptor that receives the operating instruction to the input device from the player, wherein the first effect setuper sets a plurality of skills or items at a state in which the first effect is capable of being produced, the operating instruction receptor receives a selection of a skill or an item from among the skills or the items set at the state in which the first effect is capable of being produced, and the effect producer produces the first effect of the skill or the item when the operating instruction receptor receives the selection of the skill or the item.

The player can previously set a plurality of skill cards or the like on the normal slot. The player can use the skill or the like corresponding to the skill card or the like by selecting a desired skill card or the like from among the skill cards or the like according to the progress of the game. The player needs to previously assume how the progress status of the game changes in order to select the skill or the like to be set on the normal slot from among many skill cards or the like held by the player character and use the set skill or the like according to the progress status of the game.

In the present invention, it is preferable that the game apparatus further comprising: a recovery time storage that stores a recovery time until the effect of the skill or the item becomes capable of being produced after the effect producer has produced the effect of the skill or the item, wherein the effect producer cannot produce the first effect of the skill or the item until the recovery time stored in the recovery time storage elapses after the effect producer has produced the first effect of the skill or the item.

A recovery time (recasting time) is set for each skill card or the like. Until the recasting time elapses after a skill or the like set on the normal slot has been used, the used skill or the like becomes unavailable. In other words, an unused skill or the like or the skill or the like of which recasting time has elapsed after the skill or the like has been used are available among the skills or the like set on the normal slot. The recasting time varies depending on each skill card or item card. Thus, the player needs to carefully use the skill or the like with precise timing and to more strategically use the skill or the like.

In the present invention, it is preferable that the game apparatus further comprising: a candidate setuper that sets a plurality of skills and items as candidates in which the second effect is capable of being produced; and a skill decider that determines at least a skill or an item from among the skills or the items set as the candidates by the candidate setuper, wherein the second effect setuper sets the skill or the item set by the skill decider at a state in which the second effect is capable of being produced.

Although the player can previously set a plurality of skill cards or the like on the wild slot, the player cannot use all of the skill cards or the like at a timing that the player desires. A skill card is set as an available card from among the skill cards or the like set on the wild slot. In other words, the skill cards or the like are set on the wild slot as candidates to be available. A skill card or the like is randomly determined as an actually available card or the like from among the skill cards or the like set as the candidates.

Regarding a plurality of the skill cards or the like set on the normal slot, All of the skill cards or the like are available except during their recasting times. However, the player cannot control which skill card or the like in the skill cards or the like set on the wild slot is set as an available skill card or the like. The player needs to set the normal slot and the wild slot based on the fact that the game has such an uncertainty. This can improve the interest of the game.

For example, when the wild effect is set to have a greater effect that advantageously works for the player character in the progress of the game in comparison between the normal effect when a skill card or the like is set on the normal slot and the wild effect when a skill card or the like is set on the wild slot, the player needs to strategically determine, for example, to set a skill card or the like on the normal slot in that case the effect is not so great but the timing to use the skill or the like is easily controlled, or to set a skill card or the like on the wild slot in that case the effect is great but it is difficult to control the timing to use the skill or the like.

In the present invention, it is preferable that the game apparatus further comprising: the recovery time storage that stores a recovery time until the effect of the skill or the item becomes capable of being produced after the effect producer has produced the effect of the skill or the item, wherein the effect producer cannot produce the second effect until the recovery time stored in the recovery time storage elapses after the effect producer has produced the second effect of the skill or the item.

A recovery time (recasting time) is set for each skill card or the like. Until the recasting time elapses after a skill or the like set on the wild slot has been used, not only the used skill or the like but also the other skills or the like set on the wild slot become unavailable. Even when the recasting time has elapsed, the used skill on the wild slot cannot be used again unless the fight is ended or the stage of the game changes. The recasting time varies depending on each skill card or item card. Thus, the player needs to carefully use the skill or the like with precise timing and to more strategically use the skill or the like.

The present invention relates to a game system in which a game progresses by an action of a player character according to an operating instruction to a game apparatus from a player comprising: the game apparatus; a server apparatus; an effect storage that stores a first effect and a second effect of a skill or an item; a first effect setuper that sets a skill or an item held by the player character at a state in which the first effect is capable of being produced; a second effect setuper that sets the skill or the item held by the player character at a state in which the second effect is capable of being produced; and an effect producer that produces the first effect and/or the second effect set capable of being produced by the first effect setuper and/or the second effect setuper according to the effects stored in the effect storage.

The present invention relates to a method for progressing a game in which a game progressed by an action of a player character according to an operating instruction to an input device from a player is executed in a computer device comprising: storing a first effect and a second effect of a skill or an item in a storage region; setting a skill or an item held by the player character at a state in which the first effect is capable of being produced; setting the skill or the item held by the player character at a state in which the second effect is capable of being produced; and producing the first effect and/or the second effect set capable of being produced according to the first effect and/or the second effect of the skill or the item stored in the storage region.

The present invention relates to a tangible computer readable medium that stores a game program for causing a computer device to execute a game progressed by an action of a player character according to an operating instruction to an input device from a player, the game program functioning the computer device as: an effect storage that stores a first effect and a second effect of a skill or an item; a first effect setuper that sets a skill or an item held by the player character at a state in which the first effect is capable of being produced; a second effect setuper that sets the skill or the item held by the player character at a state in which the second effect is capable of being produced; and an effect producer that produces the first effect and/or the second effect set capable of being produced by the first effect setuper and/or the second effect setuper according to the effects stored in the effect storage.

### BRIEF DESCRIPTION OF DRAWINGS

FIG. 1 is a block diagram of the configuration of a game system according to an embodiment of the present invention;

FIG. 2 is a block diagram of the configuration of a game apparatus according to the embodiment of the present invention;

FIG. 3 is a block diagram of the configuration of a server apparatus according to the embodiment of the present invention;

FIG. 4 is a view of an exemplary menu screen of the game apparatus according to the embodiment of the present invention;

FIG. 5 is a view of an exemplary skill table according to the embodiment of the present invention;

FIG. 6 is a view of an exemplary normal slot management table according to the embodiment of the present invention;

FIG. 7 is a flowchart for describing the process for producing the skill set at the normal slot according to the embodiment of the present invention;

FIG. 8 is a view of an exemplary wild slot management table according to the embodiment of the present invention;

FIG. 9 is a flowchart for describing the process for producing the skill set at the wild slot according to the embodiment of the present invention;

FIG. 10 is a view of an exemplary game screen in a fight according to the embodiment of the present invention; and

FIG. 11 is a view of an exemplary skill card information display window according to the embodiment of the present invention.

### DESCRIPTION OF EMBODIMENTS

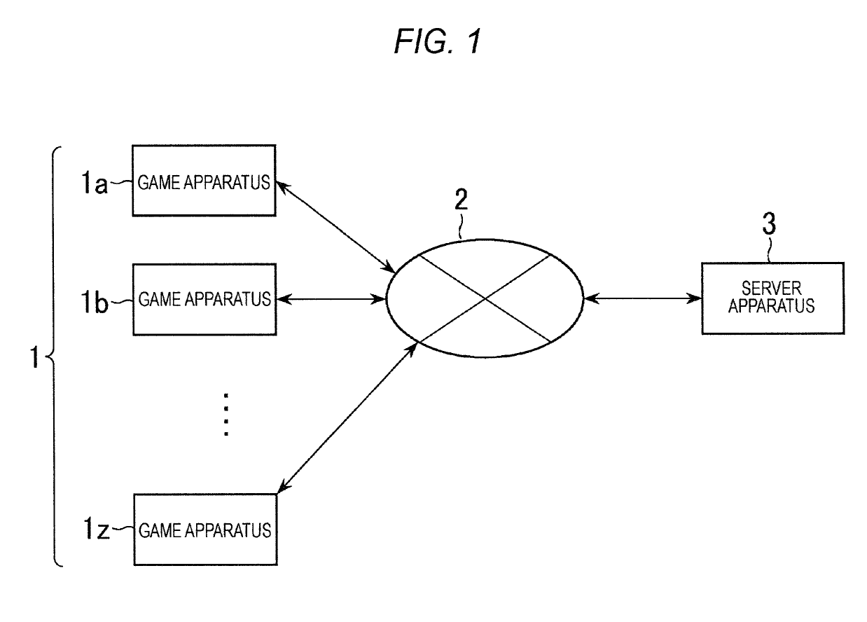

Hereinafter, an embodiment of the present invention will be described with reference to the accompanying drawings. The present embodiment will be described while the case in which the present invention is mainly applied to an MMORPG is taken as an example. FIG. 1 is a block diagram for illustrating the configuration of a game system according to the embodiment of the present invention. As illustrated in the drawing, the game system includes a plurality of game apparatuses 1 (game apparatuses 1a, 1b . . . 1z) operated by a plurality of players (players A, B . . . Z), a server apparatus 3, and a communication network 2. The game apparatuses 1 are connected to the server apparatus 3 via the communication network 2. Note that it is not necessary to constantly connect the game apparatuses 1 to the server apparatus 3. The game apparatuses 1 can be connected to the server apparatus 3 as necessary. The game apparatuses 1a to 1z are connected to the server apparatus 3 so that each of the players can play the same game with controlling a player character allotted to each of the game apparatuses 1.

At least a player character is usually allotted to each of the game apparatuses 1 in an MMORPG. Each player controls the actions such as a movement or an attack of the player character by operating each of the game apparatuses 1. For example, when an operating instruction to the player character B is input at the game apparatus 1b while the player character A allotted to the game apparatus 1a and the player character B allotted to the game apparatus 1b are located near each other in the virtual world of the game, the operating instruction information to the player character B is transmitted from the game apparatus 1b to the game apparatus 1a through the server apparatus 3.

The game apparatus 1a receives the information including the information about the operation of the player character B and to be necessary for the progress of the game from the server apparatus 3 in order to progress the game based on the information received from the server apparatus 3 and the operating instruction information input to the game apparatus 1a. The state of the virtual world changed by the progress of the game is displayed on the display screen of the game apparatus 1a after being prospectively transformed on a virtual screen.

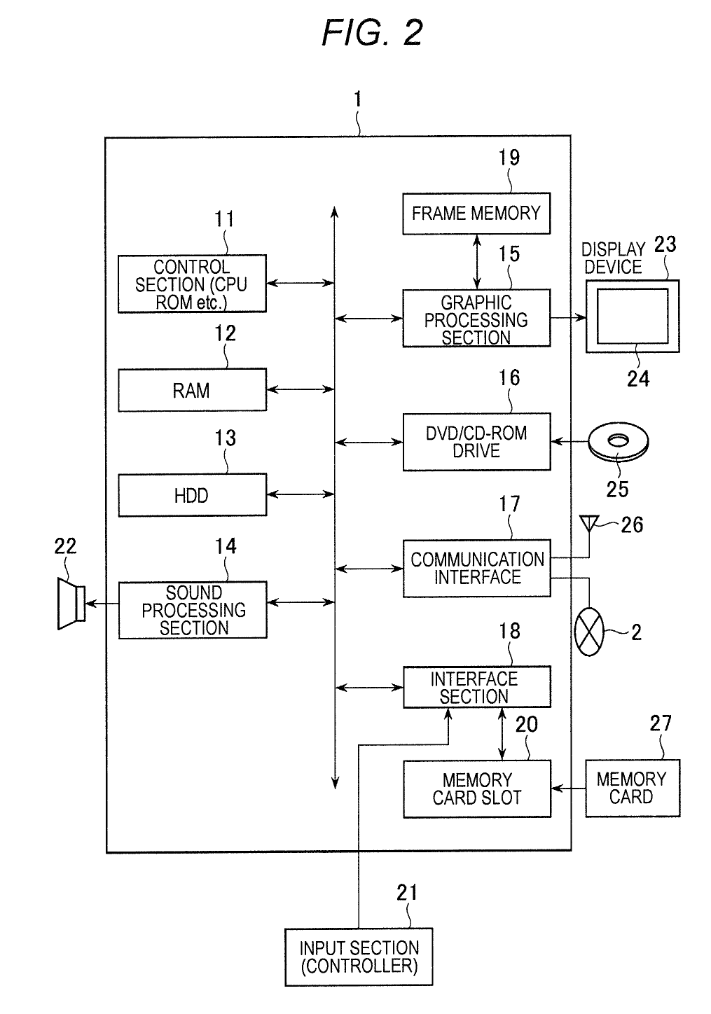

FIG. 2 is a block diagram of the configuration of a game apparatus according to the embodiment of the present invention. Each of the game apparatuses 1 includes a control section 11, a random access memory (RAM) 12, a hard disk drive (HDD) 13, a sound processing section 14, a graphic processing section 15, a DVD/CD-ROM drive 16, a communication interface 17, and an interface section 18 that are connected to each other through an internal bus.

The control section 11 includes a central processing unit (CPU) and a read only memory (ROM). The control section 11 executes a program stored in the HDD 13 or a recording medium 25 in order to control the game apparatus 1. Further, the control section 11 includes an internal timer measuring the time. The RAM 12 is a working area for the control section 11. The HDD 13 is a storage area for storing a program or data.

The DVD/CD-ROM drive 16 can install the recording medium 25 including a DVD-ROM or a CD-ROM storing a game program. The recording medium 25 stores the program or data for playing the game. The DVD/CD-ROM drive 16 reads the program and data necessary to progress the game from the recording medium 25 and the program and data are loaded into the RAM 12.

The control section 11 reads the program and data necessary to progress the game from the RAM 12 and processes the program and the data. The control section 11 outputs an instruction of the sound output to the sound processing section 14 and a drawing instruction to the graphic processing section 15 by processing the program and data loaded into the RAM 12.

The sound processing section 14 is connected to a sound output device 22 that is a speaker. When the control section 11 outputs the instruction of the sound output to the sound processing section 14, the sound processing section 14 outputs a sound signal to the sound output device 22.

The graphic processing section 15 is connected to a display device 23. The display device 23 includes a display screen 24. When the control section 11 outputs the drawing instruction to the graphic processing section 15, the graphic processing section 15 develops an image to a frame memory (frame buffer) 19 and outputs a video signal for displaying the image on the display screen 24. The graphic processing section 15 executes the drawing of an image frame by frame. For example, an image has the time per frame of one thirtieth second.

An input section (controller) 21 and a memory card slot 20 are connected to the interface section 18. The input section 21 includes, for example, a mouse so that dragging a skill card held by the player character with the mouse can set the skill card on one of a normal slot and a wild slot. Further, clicking the skill card displayed on the screen of the fight against an enemy character with the mouse, the player character can use the skill card. Additionally, operating a predetermined operation button of the input section 21 can move the player character or attack the enemy character.

The information input by the player through the input section 21 is stored in the RAM 12 so that the control section 11 performs various arithmetic computations based on the input information. Further, according to the instructions from the control section 11, the interface section 18 stores the data about the progress of the game stored in the RAM 12 in a memory card 27, or reads the data stored in the memory card 27 to transmit the data to the RAM 12.

The communication interface 17 is connected to the communication network 2 by radio or using wire in order to transmit and receive the operating instruction information or the information about the progress of the game to and from the server apparatus 3 as necessary. Further, the communication interface 17 can also communicate with the other game apparatuses 1 by radio through a communication unit having an antenna 26.

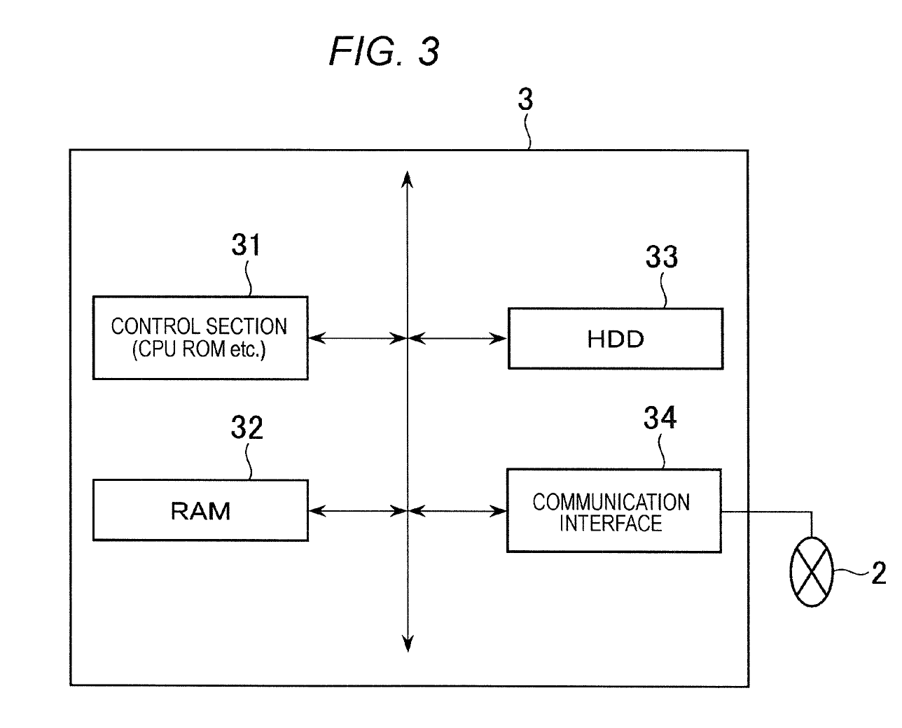

FIG. 3 is a block diagram of the configuration of the server apparatus according to the embodiment of the present invention. The server apparatus 3 includes a control section 31, a RAM 32, an HDD 33, and a communication interface 34 that are connected to each other through an internal bus.

The control section 31 includes a CPU and a ROM and executes a program stored in the HDD 33 in order to control the server apparatus 3. The control section 31 also includes an internal timer measuring the time. The RAM 32 is a working area for the control section 31. The HDD 33 is a storage area for storing a program or data. The control section 31 reads the program and data necessary to progress the game from the RAM 32 and progresses the game based on the operating instruction information received from the game apparatuses 1.

In the present invention, the skill card held by the player character can be set on one of the normal slot and the wild slot on the menu screen. The skill card shows the skill that the player character can perform. The skill card can be obtained in the progress of the game. Two effects have previously been given to the skill card so that the effect in the progress of the game changes depending on which slot, the normal slot or the wild slot, the skill card has been set on.

When the skill card is set on the normal slot, the same skill card can be used plural times in a fight stage against the enemy character. When the skill card is set on the wild slot, the same skill card can be used only once. Further, a recasting time until the skill card that has been used once can be used again is set for each of the cards so that the player needs to strategically determine which slot the player sets the card on while considering the recasting time.

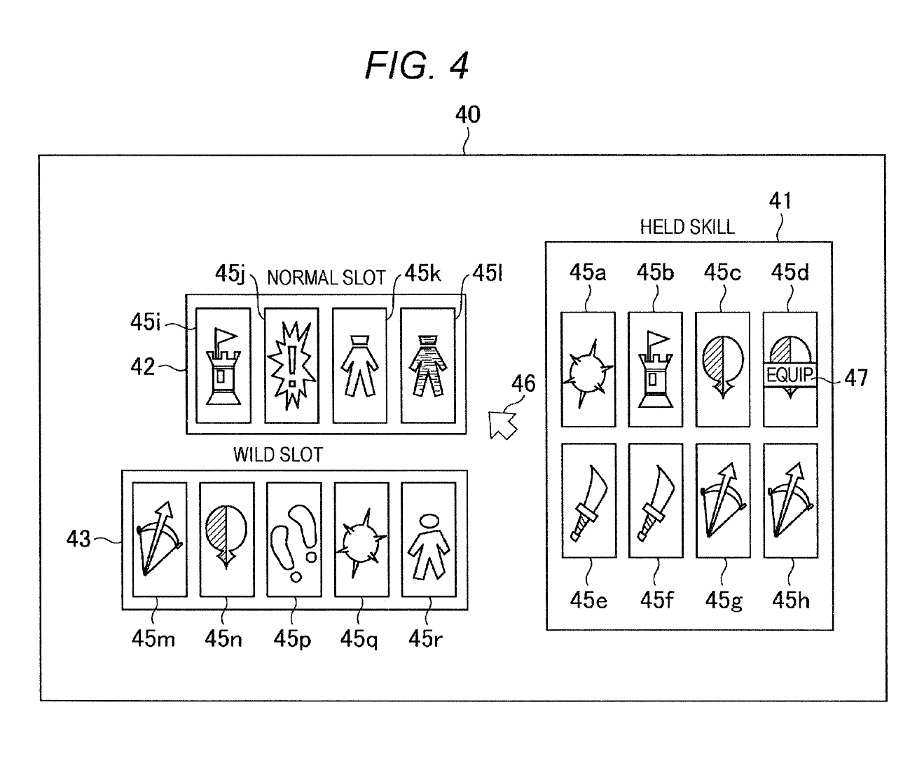

Next, the menu screen will be described. FIG. 4 is a view of an exemplary menu screen in the game apparatus according to the embodiment of the present invention. The player can set a skill card 45 on one of the normal slot and the wild slot on a menu screen 40. A pattern from which the type or characteristic of the card can be understood is displayed on the skill card 45.

A plurality of skill cards 45a to 45h that have not been set on the slot yet is placed at a held skill display region 41. The player moves a cursor 46 with the mouse of the input section 21 and designates and drags the skill card 45 with the cursor 46 in order to move the skill cards 45a to 45h that have not been set on the slot yet to a normal slot setting region 42 or a wild slot setting region 43, so that the skill cards 45a to 45h can be set on the normal slot or the wild slot. The skill card 45 that has already been set on the normal slot or the wild slot is attached with an equipment display 47 showing “EQUIP” illustrated as the slot card 45d.

A plurality of skill cards 45 (for example, four cards) can be placed at the normal slot setting region 42. Skill cards 45i to 45l have already been set on the normal slot setting region 42 in FIG. 4. In other words, a plurality of skill cards 45 can be set on the normal slot. The player can select and use the skill cards 45 set on the normal slot at an arbitrary timing in the fight of the enemy character.

Similarly to the normal slot setting region 42, a plurality of skill cards 45 (for example, five cards) can be placed at the wild slot setting region 43. Skill cards 45m to 45r have already been set on the wild slot setting region 43 in FIG. 4. In other words, a plurality of skill cards 45 can also be set on the wild slot.

However, all of the skill cards 45 set on the wild slot cannot freely be selected and used. The cards are candidate to be available. Only a skill card 45 is randomly determined as an available card from among the skill cards 45 placed at the wild slot setting region 43 at a predetermined timing, for example, at the end of the edit on the menu screen or at the beginning of the fight. After the available skill card 45 has been used and the recasting time has elapsed, a new skill card 45 is randomly determined as an available card from among the skill cards 45 other than the already used skill card 45.

Placing the skill card 45 at one of the held skill display region 41, the normal slot setting region 42, and the wild slot setting region 43 on the menu screen 40 can appropriately change whether the skill card 45 is set at the normal slot, the wild slot, or is not set at the slots. Further, the timing when the placement of the skill card 45 can be changed on the menu screen 40 can appropriately be determined. For example, the placement of the skill card 45 can be changed only at the beginning of the fight against the enemy character or the start of a stage, or the placement of the skill card 45 can also be changed at an arbitrary timing in the fight against the enemy character.

When the same types of the skill cards 45 are held, for example, the same types of the skill cards 45 can be set on the normal slot and the wild slot, respectively, as the skill card 45k and the skill card 45r. However, the same types of the skill cards 45 cannot be set at the normal slot, nor the same types of the skill cards 45 cannot be set at the wild slot.

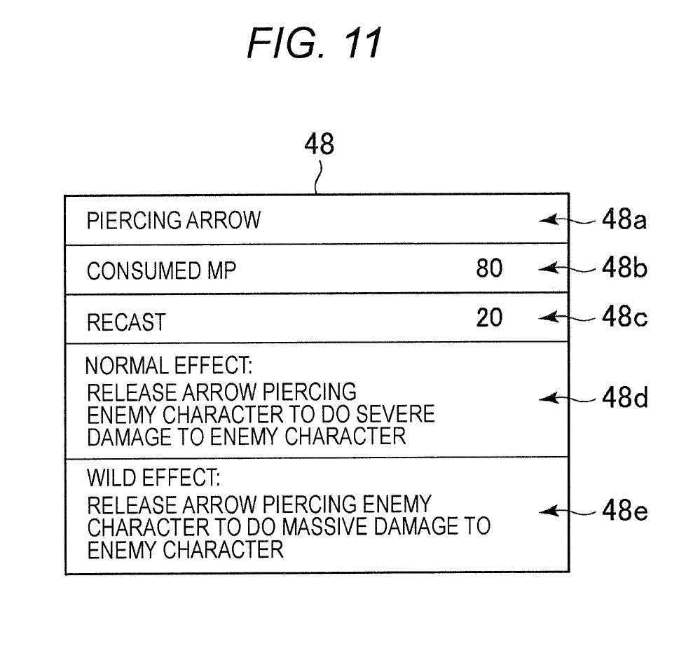

Double-clicking or right-clicking on the skill card 45 displayed on the menu screen 40 with the mouse of the input section 21 displays a skill card information display window 48 as illustrated in FIG. 11 on the menu screen 40. The skill card information display window 48 includes a name display region 48a, a consumed MP display region 48b, a recasting display region 48c, a normal effect display region 48d, and a wild effect display region 48e. The player can consider which slot the skill card 45 is set on while using the information. Note that the unit of the recasting time displayed at the recasting display region is “second” in FIG. 11.

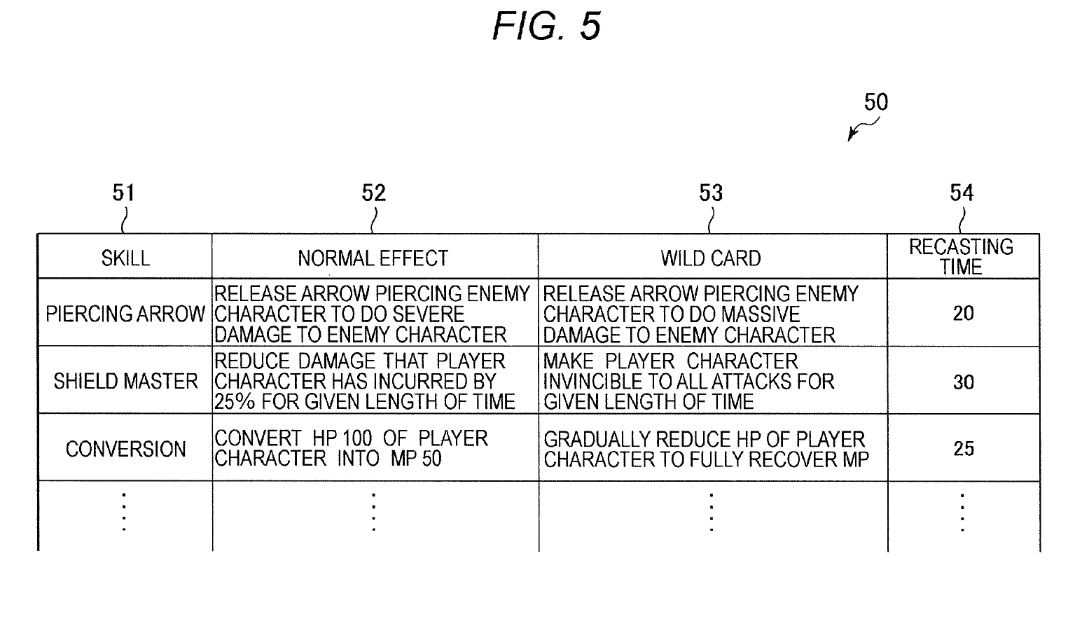

Next, a skill table will be described. FIG. 5 is a view of an exemplary skill table according to the embodiment of the present invention. A skill table 50 is configured to store the skill that the player character can use and the effect. The skill table 50 is set in the RAM 12. The skill table 50 stores a normal effect 52, a wild effect 53 and a recasting time 54 in association with each skill 51 coming into the game. The normal effect 52 is produced when the skill card corresponding to the skill 51 is set on the normal slot. The wild effect 53 is produced when the skill card corresponding to the skill 51 is set on the wild slot.

For example, when the skill 51 is a skill called “piercing arrow”, the normal effect 52 gives the effect of “releasing an arrow piercing the enemy character to do severe damage to the enemy character” and the wild effect 53 gives the effect of “releasing an arrow piercing the enemy character to do massive damage to the enemy character”. In that case, both of the effects have the same characteristic and type whereas having different sizes. Further, when the skill 51 is a skill called “shield master”, the normal effect 52 gives the effect of “reducing the damage that the player character has incurred by 25% for a given length of time” and the wild effect 53 gives the effect of “making the player character invincible to all attacks for a given length of time”. In that case, both of the effects have relatively similar characteristics and types. Further, when the skill 51 is a skill called “conversion”, the normal effect 52 gives the effect of “converting the HP (hit points) 100 of the player character into MP (magic points) 50” and the wild effect 53 gives the effect of “gradually reducing the HP of the player character to fully recover the MP”. In that case, both of the effects have different characteristics and types.

As described above, effects having the same characteristics and types and different sizes can be adopted as the normal effect 52 and the wild effect 53, effects having similar characteristics and types can also be adopted, or effects having different characteristics and types can also be adopted.

The recasting time 54 is configured to specify the time until the skill 51 becomes available next after the skill 51 has been used. A different time is determined for each of the skills 51. Note that, in FIG. 5, the same recasting time 54 is adopted even when the skill card is set on either of the normal slot and the wild slot. However, a different recasting time 54 can be adopted depending on which slot, the normal slot or the wild slot, the skill card is set on.

For example, during a fight, after the player character has used the skill “piercing arrow” set on the normal slot, the player character cannot use the “piercing arrow” until the recasting time of 20 seconds has elapsed from the time when the player character has used the “piercing arrow”. However, when the “shield master” is set on the normal slot in addition to the “piercing arrow”, the player character can use the “shield master” even before the “20 second” that is the recasting time 54 of the “piercing arrow” elapses after the player character has used the “piercing arrow”. After the recasting time 54 has elapsed, the player character can use the “piercing arrow” again. The player character can repeatedly use the same skill over and over except during the recasting time 54.

Once the player gives the operating instruction to the input section 21 to use the skill card 45 set on the wild slot, the player cannot use all of the skill cards 45 set on the wild slot until the recasting time 54 elapses. After the recasting time 54 has elapsed, only one of the skill cards 45 set on the wild slot is randomly determined and becomes available.

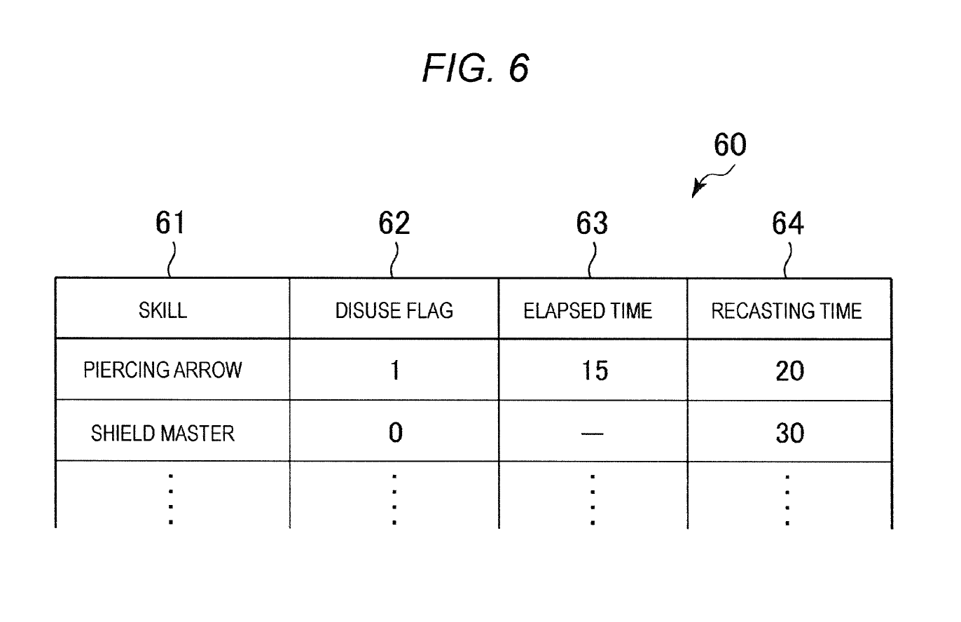

Next, a normal slot management table will be described. FIG. 6 is a view of an exemplary normal slot management table according to the embodiment of the present invention. A normal slot management table 60 is configured to manage the skill set on the normal slot. When a plurality of skill cards 45 are set on the normal slot, all skills 61 corresponding to the skill cards 45 are registered in the normal slot management table 60. The normal slot management table 60 stores a disuse flag 62, an elapsed time 63 after the skill has been used, and a recasting time 64 in association with the skill 61 set on the normal slot.

Placing the skill card 45 on the normal slot setting region 42 on the menu screen 40 registers a skill corresponding to the skill card 45 as the skill 61 in the normal slot management table 60. Further, placing the skill card 45 placed at the normal slot setting region 42 to another region on the menu screen 40 unsets the registration in the normal slot management table 60.

The disuse flag 62 is set by the use of the skill 61 set on the normal slot by the player character. Using the skill 61 causes the measurement of time to start. When the elapsed time 63 after the skill has been used reaches the recasting time 64, the disuse flag 62 is unset and the elapsed time 63 is reset. Note that the recasting time 64 has the same value as the recasting time 54 in the skill table 50.

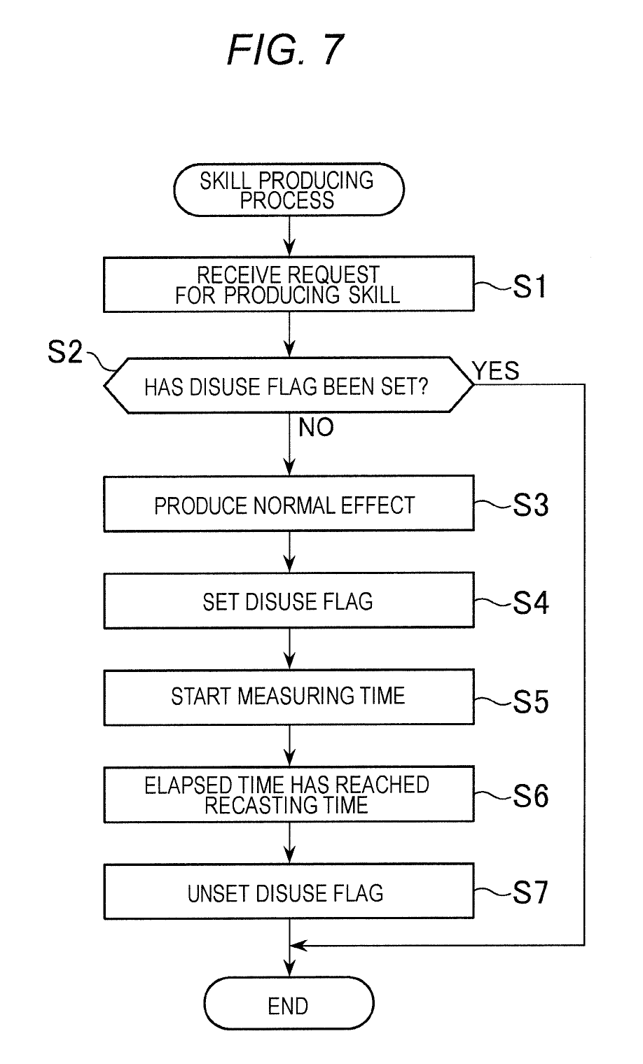

Next, a process for producing the skill set on the normal slot will be described. FIG. 7 is a flowchart for describing the process for producing the skill set on the normal slot according to the embodiment of the present invention. The operating instruction to the input section 21 from the player causes the reception of a request for the production of the skill set on the normal slot (step S1). The player requests the production of a skill by selecting a skill card 45 corresponding to the skill that the player wants to use from among a plurality of the skill cards 45. Further, the production of the skill can be requested at an arbitrary timing in the progress of the game that is desired by the player.

After the request for the production of the skill has been received, it is determined whether the disuse flag 62 in the normal slot management table 60 is set on the received skill (step S2). When the disuse flag 62 is set (YES in step S2), the skill is not produced and the process is terminated because the elapsed time 63 from the last time the skill has been used has not reached the recasting time. On the other hand, when the disuse flag 62 is not set (NO in step S2), the skill table 50 is referred to and the normal effect corresponding to the selected skill is produced (step S3).

Next, the disuse flag 62 is set in the normal slot management table 60 (step S4) and the measurement of the elapsed time 63 after the skill has been used is started (step S5). While the disuse flag 62 is set, the used skill cannot be used again. When the elapsed time 63 after the skill has been used reaches the recasting time 64 (step S6), the disuse flag 62 is unset (step S7) and a series of procedures are completed. Unsetting the disuse flag 62 makes the skill available again. Note that a plurality of skills is set on the normal slot and the process including steps S1 to S7 is performed for each of the skills in parallel.

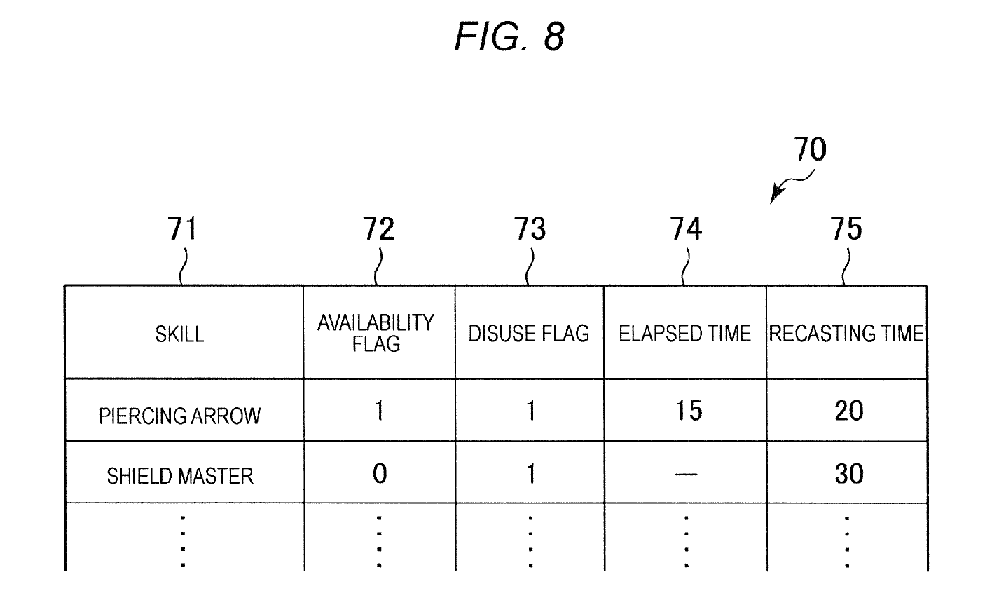

Next, a wild slot management table will be described. FIG. 8 is a view of an exemplary wild slot management table according to the embodiment of the present invention. A wild slot management table 70 is configured to manage the skill set on the wild slot. When a plurality of skill cards 45 are set on the wild slot, all skills 71 corresponding the skill cards 45 are registered in the wild slot management table 70. The wild slot management table 70 stores an availability flag 72, a disuse flag 73, an elapsed time 74 after the skill has been used and a recasting time 75 in association with the skill 71 set on the wild slot.

Placing the skill card 45 at the wild slot setting region 43 on the menu screen 40 registers a skill corresponding to the skill card 45 as the skill 71 in the wild slot management table 70. Further, placing the skill card 45 placed at the wild slot setting region 43 to another region on the menu screen 40 unsets the registration in the wild slot management table 70.

The availability flag 72 is set, for example, only on a skill 71 from among all of the skills 71 registered in the wild slot management table 70. The skills 71 set on the wild slot are candidates to be available. Only one of the skills 71 becomes available at a certain point. The availability flag 72 is set on the skill determined as the available skill. Accordingly, the availability flag 72 set on a skill A is unset with the elapse of the recasting time 75 after the skill A has been used. The availability flag 72 is set on a skill B determined as a new available skill from among the skills on which the disuse flags 73 are not set.

The disuse flag 73 is set by the use of the skill 71 set on the wild slot by the player character. Using the skill 71 causes the measurement of time to start. When the elapsed time 74 after the skill has been used reaches the recasting time 75, the elapsed time 74 is reset. Even when the elapsed time 74 after the skill has been used has reached the recasting time 75, the disuse flag 73 is not unset. Thus, the skill 71 set on the wild slot can be used only once in the fight. Note that the recasting time 75 has the same value as the recasting time 54 in the skill table 50.

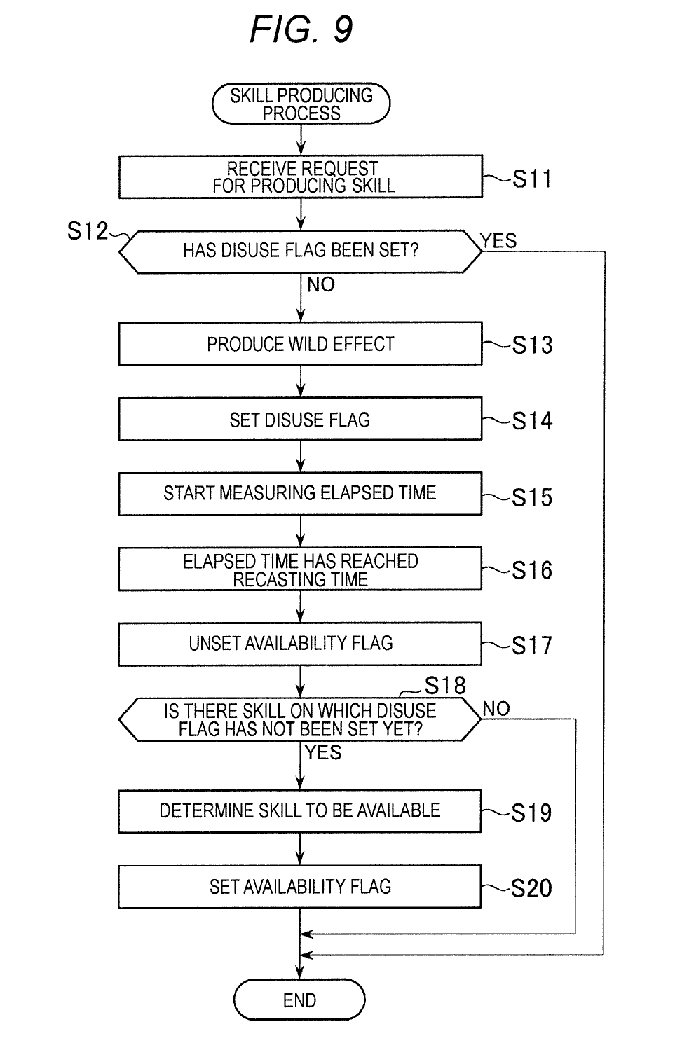

Next, a process for producing the skill set on the wild slot will be described. FIG. 9 is a flowchart for describing the process for producing the skill set on the wild slot according to the embodiment of the present invention. The operating instruction to the input section 21 from the player causes the reception of a request for the production of the skill set on the wild slot (step S11). The production of the skill can be requested at an arbitrary timing in the progress of the game that is desired by the player.

After the request for the production of the skill has been received, it is determined whether the disuse flag 73 is set on the skill 71 on which the availability flag 72 is set (step S12). When the disuse flag 73 is set (YES in step S12), the process is terminated. On the other hand, when the disuse flag 73 is not set (NO in step S12), the skill table 50 is referred to and the wild effect corresponding to the selected skill is produced (step S13).

Next, the disuse flag 73 is set in the wild slot management table 70 (step S14) and the measurement of the elapsed time 74 after the skill has been used is started (step S15). When the elapsed time 74 after the skill has been used reaches the recasting time 75 (step S16), the availability flag 72 on the produced skill 71 is unset (step S17).

Then, it is determined whether there is a skill 71 on which the disuse flag 73 has not been set yet (step S18). When there is not a skill 71 on which the disuse flag 73 has not been set yet (NO in step S18), it is determined that all of the skills 71 set on the wild slot have been used and the process is terminated. On the other hand, when there is a skill 71 on which the disuse flag 73 has not been set yet (YES in step S18), a skill to be available is randomly determined from among the skills on which the disuse flag 73 has not been set (step S19). The availability flag 72 is set on the determined skill 71 (step S20) and the process is completed.

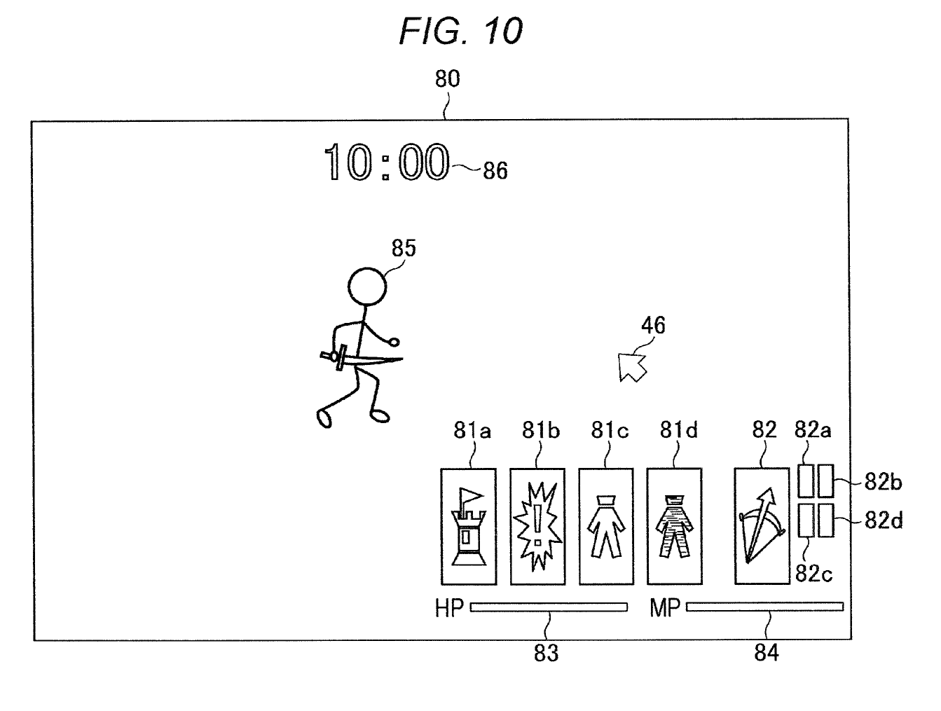

Next, the game screen in a fight will be described. FIG. 10 is a view of an exemplary game screen in the fight according to the embodiment of the present invention. A player character 85 controlled by the player is displayed at the center of a game screen 80. The player can move the player character 85 by operating the input section 21. Further, a remaining fight time 86 is displayed at the upper center of the game screen 80. The remaining fight time 86 becomes less as the time elapses. When the remaining fight time 86 becomes “zero”, the fight is ended.

A hit point (HP) 83 and magic point (MP) 84 of the player character 85 are displayed at the lower right part of the game screen 80 and skill cards 81a to 81d set on the normal slot are displayed above the HP and the MP. The player can use the skill corresponding to the skill card 81 by moving the cursor 46 to select one of the skill cards 81a to 81d. Using the skill produces the normal effect.

The selected skill card 81 is displayed in a different form, for example, in which the pattern is lightly displayed or in which the color of the card is changed until the recasting time corresponding to the skill elapses. The player can understand whether the skill is available at the sight of the display of the skill card 81. When the recasting time has elapsed, the display of the skill card 81 returns to the original form and the skill is available again.

An available skill card 82 from among the skill cards set on the wild slot is displayed at the right side of the skill cards 81 set on the normal slot. Further, reduced-size skill cards 82a to 82d that show the other skill cards set on the wild slot are displayed at the right side of the skill card 82. The player can use the skill corresponding to the skill card 82 by moving the cursor 46 and selecting the skill card 82. Using the skill produces the wild effect.

The selected skill card 82 is displayed in a different form, for example, in which the pattern is lightly displayed or in which the color of the card is changed until the recasting time corresponding to the skill elapses. When the recasting time has elapsed and a new skill card 82 is determined as an available skill card, a skill card 82 having a different pattern is displayed at the same place.

The case in which the above-mentioned embodiment is mainly applied to a network game including an MMORPG has been described. However, the present invention is not limited to the embodiment. The present invention can also be applied to a single player game using a stationary game machine or a portable game machine. Further, there is not a specific limit on the type of game and thus the present invention can be used for an action game or the like in addition to an RPG.

### REFERENCE SIGNS LIST

1 GAME APPARATUS
11 CONTROL SECTION
12 RAM
13 HDD
14 SOUND PROCESSING SECTION
15 GRAPHIC PROCESSING SECTION
16 DVD/CD-ROM DRIVE
17 COMMUNICATION INTERFACE
18 INTERFACE SECTION
19 FRAME MEMORY
20 MEMORY CARD SLOT
21 INPUT SECTION
22 SPEAKER
23 DISPLAY DEVICE
24 DISPLAY SCREEN
25 RECORDING MEDIUM
26 ANTENNA
27 MEMORY CARD
2 COMMUNICATION NETWORK
3 SERVER APPARATUS
31 CONTROL SECTION
32 RAM
33 HDD
34 COMMUNICATION INTERFACE
40 MENU SCREEN
50 SKILL TABLE
60 NORMAL SLOT MANAGEMENT TABLE
70 WILD SLOT MANAGEMENT TABLE

1. A game apparatus in which a game progresses according to an operating instruction provided to an input device from a player, the game apparatus comprising:
a memory of the game apparatus that stores a list of game mediums of a player, and a first effect and a second effect corresponding to each of the game mediums, the second effect being different from the first effect,
a processor of the game apparatus configured to perform operations including:
designating, in accordance to the operating instruction provided from the player via an input device of the game apparatus, a game medium to have, at a single point in time, only one of the first effect or the second effect for the game medium;
when the game medium is designated to have the first effect, retrieving, from the memory, the first effect of the game medium to be applied upon execution;
when the game medium is designated to have the second effect, retrieving, from the memory, the second effect of the game medium to be applied upon execution; and
when the first effect or the second effect is available for execution and executed, producing the one of the first effect or the second effect designated for the game medium according to the first effect and the second effect of the game medium stored in the memory.

2. The game apparatus according to claim 1,
wherein the designation of the first effect or the second effect for the game medium is executed in advance of a battle.

3. The game apparatus according to claim 1,
wherein availability of the second effect for the game medium for execution is set during a battle, and
when the second effect is available for execution, the second effect designated for the game medium is produced by the operating instruction provided from the player.

4. The game apparatus according to claim 1,
wherein availability of the second effect is limited after producing the second effect designated for the game medium.

5. A non-transitory computer readable storage medium that stores a computer program, the computer program, when executed by a processor, causing a game apparatus having an input device, the processor and a memory to perform a process, the process comprising:
storing, in the memory of the game apparatus, a list of game mediums of a player, and a first effect and a second effect corresponding to each of the game mediums, the second effect being different from the first effect;
receiving, via the input device, an operating instruction;
designating, in accordance to the operating instruction, a game medium to have, at a single point in time, only one of a first effect or a second effect for the game medium;
when the game medium is designated to have the first effect, retrieving, from the memory, the first effect of the game medium to be applied upon execution;
when the game medium is designated to have the second effect, retrieving, from the memory, the second effect of the game medium to be applied upon execution; and
when the first effect or the second effect is available for execution and executed, producing the one of the first effect or the second effect designated for the game medium according to the first effect and the second effect of the game medium stored in the memory.

6. A method for progressing a game executed on a game apparatus having an input device, a processor and a memory, the method comprising:
storing, in the memory of the game apparatus, a list of game mediums of a player, and a first effect and a second effect corresponding to each of the game mediums, the second effect being different from the first effect;
receiving, via the input device, an operating instruction;
designating, by the processor and in accordance to the operating instruction, a game medium to have, at a single point in time, only one of a first effect or a second effect for the game medium;
when the game medium is designated to have the first effect, retrieving, by the processor and from the memory, the first effect of the game medium to be applied upon execution;
when the game medium is designated to have the second effect, retrieving, by the processor and from the memory, the second effect of the game medium to be applied upon execution; and
when the first effect or the second effect is available for execution and executed, producing, by the processor, the one of the first effect or the second effect designated for the game medium according to the first effect and the second effect of the game medium stored in the memory.
